(19) United States
(12) Patent Application Publication
(10) Pub. No.: US 2025/0188946 A1
(43) Pub. Date: Jun. 12, 2025

(54) FAN BLADE DECORATION

(71) Applicant: Troy Wertz, Castle Rock, CO (US)

(72) Inventor: Troy Wertz, Castle Rock, CO (US)

(21) Appl. No.: 18/979,127

(22) Filed: Dec. 12, 2024

Related U.S. Application Data
(60) Provisional application No. 63/608,946, filed on Dec. 12, 2023.

(51) Int. Cl. F04D 29/38; F21V 23/04

(52) U.S. Cl. CPC F04D 29/38; F21V 23/0471

(57) ABSTRACT

A fan blade decoration includes a clip, a tether and an ornament. The clip may function to removably secure the fan blade decoration to a blade of a fan. The fan blade decoration may be configured to provide a decoration which provides beauty, light, enjoyment, or the like to a room or space containing a fan. The fan blade decoration may be configured to move with a fan when the fan is in motion. The ornament of the fan blade decoration may be comprised of one or more functional components such as lights, whistles, wheels, or the like.

### RELATED APPLICATIONS

This application claims priority to U.S. Provisional Application Ser. No. 63/608,946, filed Dec. 12, 2023.

### BACKGROUND OF THE INVENTION

Ornaments, pictures, paintings, posters, wall hangings, etc. have been known and used by people to brighten and decorate homes, offices, and other frequented places for a very long time. Oftentimes, a person, will not only decorate a space or spaces, but they will frequently switch out the décor depending on the season, holiday, or to just get a new feeling in a room or area.

Therefore, new designs and functional features for décor that would help liven and brighten homes, offices, and other frequented places would be well received by the general public.

### SUMMARY OF THE INVENTION

A fan blade decoration system may include a fan having one or more fan blades and one or more fan blade decorations. The one or more fan blade decorations may be comprised of a clip, a tether, and an ornament. The clip may be configured to removably secure to one of the fan blades. The tether may be configured to attach an ornament to the clip. The ornament may be configured to move with the fan blade when the fan is in motion. The clip and ornament may each be comprised of one or more of glitter, bright paint, lights, a shining luster, a reflective material, a scented material or the like. The ornament and the clip may each be comprised to emit a fragrance when in motion. The clip, tether, and ornament may be comprised of a photoluminescent material. The clip and ornament may each be configured to emit a sound when in motion.

### BRIEF DESCRIPTION OF THE DRAWINGS

Various embodiments will be described and explained with additional specificity and detail through the use of the accompanying drawings in which:

FIG. 1 illustrates a perspective view of a fan blade decoration;

FIG. 2 illustrates a perspective view of an alternative embodiment of the fan blade decoration of FIG. 1;

FIG. 3 illustrates a perspective view of another alternative embodiment of the fan blade decoration of FIG. 1;

FIG. 4 illustrates a perspective view of another alternative embodiment of the fan blade decoration of FIG. 1;

FIG. 5 illustrates a perspective view of another alternative embodiment of the fan blade decoration of FIG. 1;

FIG. 6 illustrates a perspective view of another alternative embodiment of the fan blade decoration of FIG. 1;

FIG. 7 illustrates a perspective view of another alternative embodiment of the fan blade decoration of FIG. 1;

FIG. 8 illustrates a perspective view of another alternative embodiment of the fan blade decoration of FIG. 1;

FIG. 9 illustrates a perspective view of another alternative embodiment of the fan blade decoration of FIG. 1;

FIG. 10 illustrates a perspective view of another alternative embodiment of the fan blade decoration of FIG. 1;

FIG. 11 illustrates a perspective view of another alternative embodiment of the fan blade decoration of FIG. 1;

FIG. 12 illustrates a perspective view of another alternative embodiment of the fan blade decoration of FIG. 1;

FIG. 13 illustrates a perspective view of another alternative embodiment of the fan blade decoration of FIG. 1;

FIG. 14 illustrates a perspective view of another alternative embodiment of the fan blade decoration of FIG. 1; and

FIG. 15 illustrates an environmental view of multiple fan blade decorations of FIG. 2 each removably attached to a fan blade.

### DETAILED DESCRIPTION OF THE PREFERRED EMBODIMENTS

As shown in the drawings and for purposes of illustration, the one or more embodiments disclosed herein illustrate a fan blade decoration general referred to herein by the reference numeral 10. Generally, the fan blade decoration 10 may be attached to a blade of a fan. Preferably, multiple fan blade decorations 10 will be in use such that each blade of a fan will have a fan blade decoration 10 attached. The fan blade decoration 10 may be configured such that it removably attaches to a single blade of a fan.

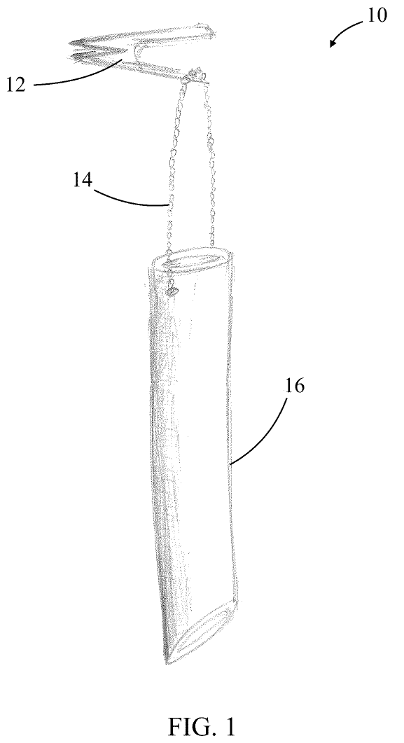

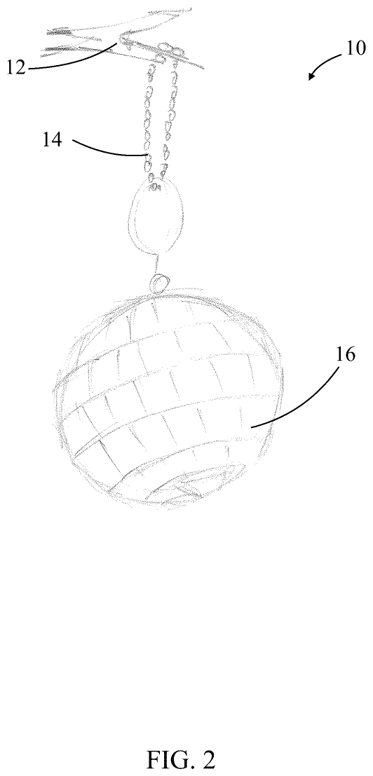

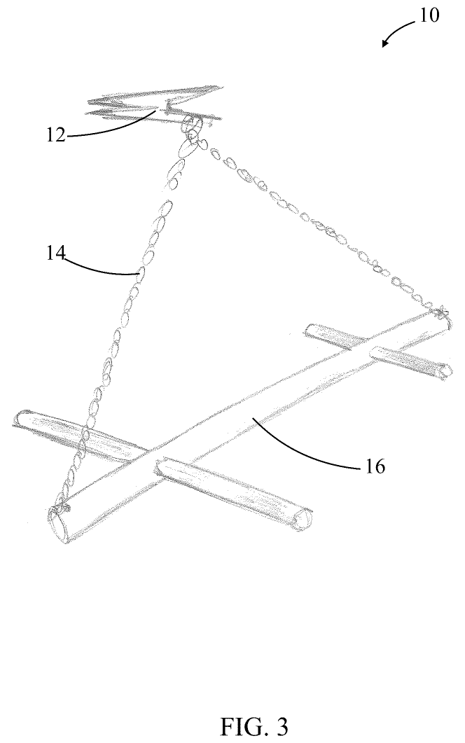

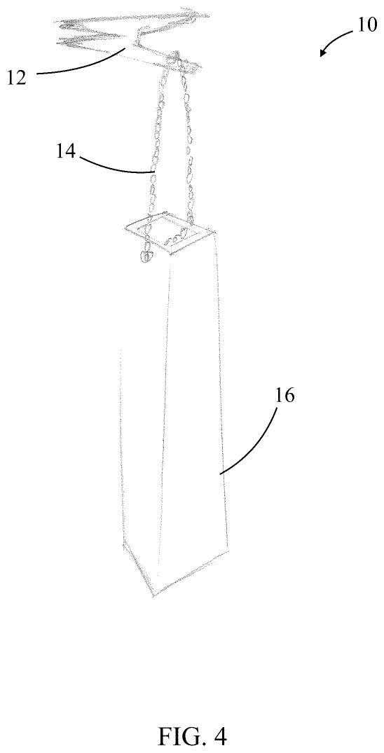

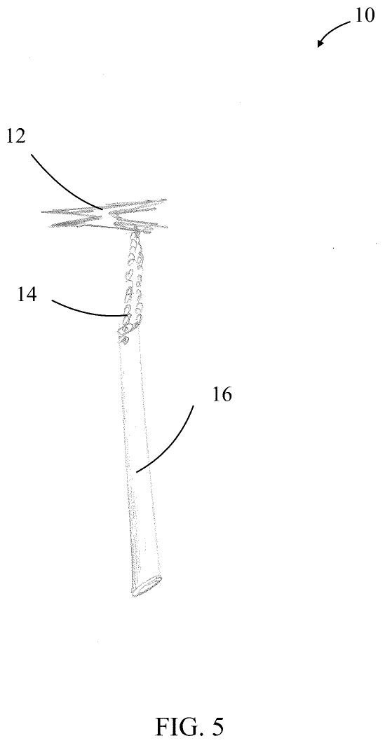

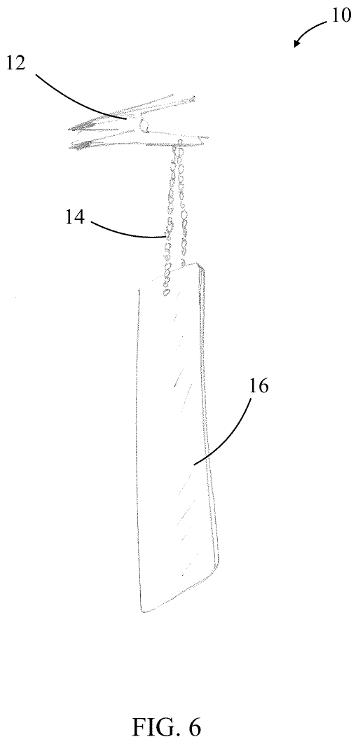

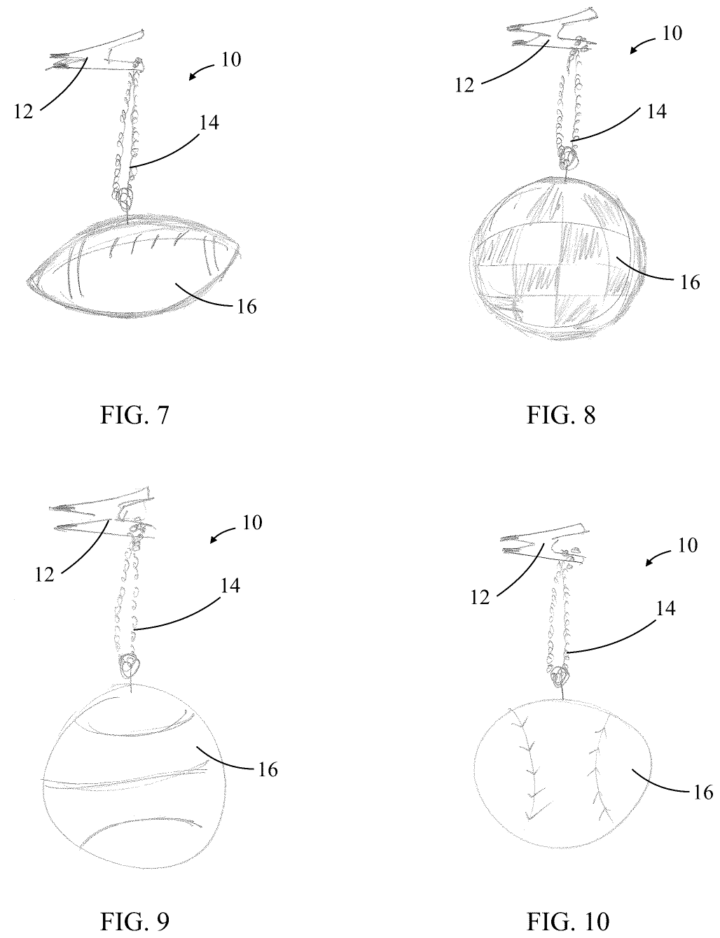

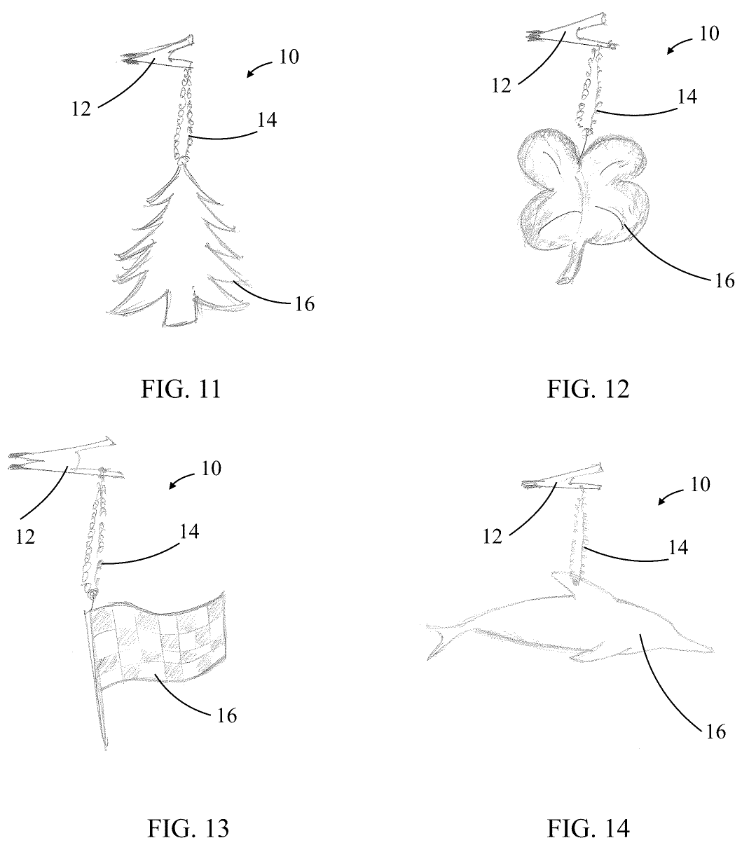

FIGS. 1-14 illustrate various embodiments of the fan blade decoration 10. Generally, each embodiment of the fan blade decoration may include a clip 12, a tether 14, and an ornament 16. The clip 12 may function to removably secure the fan blade decoration 10 to a single blade of a fan. The ornament 16 may be secured to the clip 12 by the tether 14. The clip 12 may be configured to apply enough pressure to a fan blade such that the fan blade decoration 10 does not become dislodged from the fan blade as the fan is in motion while not damaging the fan blade.

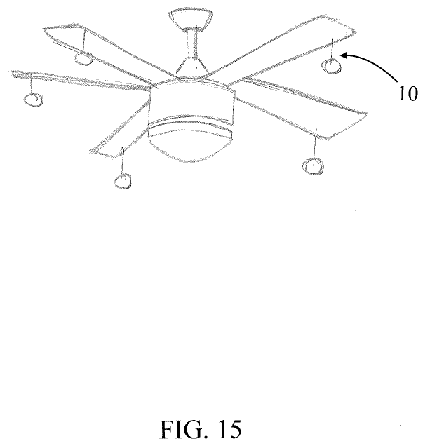

In some embodiments, the clip 12 may have a clamping portion and a compression portion. The clamping portion may be configured to apply pressure against a fan blade. The compression portion may be configured to allow a user to compress the clip 12 and thereby open the clamping portion to allow the user to removably secure the clip 12 and consequently, the fan blade decoration 10 to the fan blade as best seen in FIG. 15. The compression portion may have two arms that are compressed toward each other. The two arms may be on swivels to allow the arms to be tucked out of sight after the clip 12 is clamped onto the fan blade.

In some embodiments, the clip 12 may be configured to have a profile and appearance that mimic the edge of a fan blade. In such embodiments, the clip 12 1 may blend in with the fan blade when removably secured onto the fan blade such that the clip 12 may be hard to notice.

In other embodiments, the clip 12 may be configured to stand out from the fan blade. In such embodiments, the clip 12 may contain one or more of glitter, bright paint, lights, a shining luster, a reflective material, a scented material or the like. In some embodiments, the clip 12 may be comprised of a photoluminescent material.

In some embodiments, the clip 12 may be configured to emit a fragrance. In some embodiments, the clip 12 may be comprised of a compartment configured to receive and hold a fragrance 12. The compartment may be further configured to allow the fragrance to slowly release from the compartment. In some embodiments, the fragrance may be an essential oil applied to cotton, fabric, or the like that is stored within the compartment of the clip 12.

The tether 14 may function to connect the ornament 16 to the clip 12. The tether 14 may be a strong and durable material configured to hold the ornament 16 to the clip 12 as the fan is in motion with the fan blade decoration 10 connected. In some embodiments, the tether 14 may be configured to stand out. In such embodiments, the tether 14 may be bright in color, may be photoluminescent, may be of a reflective material, may be of a shiny material, may contain lights, may contain fiber optic lights, may be of a scented material, or the like. The tether 14 may be comprised of a chain, string, band, or other similar material.

In other embodiments, the tether 14 may be configured to blend in with the environment. In such embodiments, the tether 14 may not be easily noticed. In some embodiments, the tether 14 may be composed of a translucent material. In some embodiments, the tether 14 may be composed of a transparent material.

The ornament 16 of the fan blade decoration may be configured to be a decorative piece that stands out and is easily noticeable. In some embodiments, the ornament 16 may be comprised of one or more of glitter, bright paint, lights, a shining luster, a reflective material, a scented material, or the like. In other embodiments, the ornament 16 may be comprised of a photoluminescent material. The ornaments 16 may come in many different shapes and styles.

In some embodiments, the ornament 16 may be a solid piece that is decorative in style. The ornament 16 in these embodiments may come in a variety of different shapes, styles, and representations.

In other embodiments, the ornament 16 may have various functionality. For example, in one embodiment, the ornament 16 may have a motion sensor configured to cause a reaction in the ornament upon movement, such as when the fan to which the fan blade decoration 10 is connected turns on. The reaction may be one or more of flashing lights coming on, solid lights coming on, a sound being emitted such as music, or other noises, or the like.

In some embodiments, the ornament 16 may be comprised of features that react to air movement. For example, in some embodiments, the ornament 16 may be comprised of a whistle configured to emit a sound when the ornament 16 is in motion through the air. In other embodiments, the ornament 16 may comprise a decorative wheel configured to spin when moving through the air. In other embodiments, the ornament 16 may be comprised of chimes configured to clank together emitting sound while in motion.

In some embodiments, the ornament 16 may be configured to emit a fragrance. In some embodiments, the ornament 16 may be comprised of a compartment configured to receive and hold a fragrance. The compartment may be further configured to allow the fragrance to slowly release from the compartment. In some embodiments an essential oil may be applied to cotton, fabric, or the like and inserted into the compartment.

One skilled in the art would recognize that although several embodiments have been described above, many of the features of the various embodiments may be combined to form one embodiment. Furthermore, although several embodiments have been described in detail for purpose of illustration, various modifications may be made without departing from the scope and spirit of the invention. Accordingly, the invention is not to be limited except as by the appended claims.

What is claimed is:

1. A fan blade decoration system comprising:
a fan having one or more fan blades; and
one or more fan blade decorations each comprising a clip, a tether and an ornament, wherein each clip is configured to removably secure to one fan blade, wherein each tether is configured to secure each ornament to each clip, and wherein each fan blade decoration is configured to spin with the fan blade to which it is attached when the fan is in motion.

2. The fan blade decoration system of claim 1 wherein each ornament is identical.

3. The fan blade decoration system of claim 1 wherein each ornament is distinct.

4. The fan blade decoration system of claim 1 wherein the clip is comprised of a photoluminescent material.

5. The fan blade decoration system of claim 1 wherein the tether is comprised of a photoluminescent material.

6. The fan blade decoration system of claim 1 wherein the ornament is comprised of a photoluminescent material.

7. The fan blade decoration system of claim 1 wherein the ornament is configured to emit a sound when in motion.

8. The fan blade decoration system of claim 7 wherein the ornament is configured to whistle when in motion.

9. The fan blade decoration system of claim 1 wherein the ornament is further comprised of a chamber configured to receive a fragrance, wherein the ornament emits the fragrance when in motion.

10. The fan blade decoration system of claim 1 wherein the ornament is further comprised of a motion sensor powered by a battery and a light, wherein the motion sensor will signal the light to activate when the ornament is in motion.

11. The fan blade decoration system of claim 10 wherein the light flashes when activated.

12. The fan blade decoration system of claim 10 wherein the light turns on solid when activated.

13. The fan blade decoration system of claim 1 wherein the ornament is comprised of a reflective material.

14. The fan blade decoration system of claim 1 wherein the clip is comprised of a reflective material.

15. The fan blade decoration system of claim 1 wherein the tether is comprised of a reflective material.

16. The fan blade decoration system of claim 1 wherein the tether is comprised of a transparent material.

17. The fan blade decoration system of claim 1 wherein the clip is configured to blend in with the color of the fan blade.

18. The fan blade decoration system of claim 1 wherein the clip is configured to emit a light when in motion.

19. The fan blade decoration system of claim 1 wherein the clip is configured to emit a sound when in motion.

20. The fan blade decoration system of claim 1 wherein the clip is configured to emit a fragrance when in motion.
